(19) United States
(12) Patent Application Publication
(10) Pub. No.: US 2006/0062299 A1
(43) Pub. Date: Mar. 23, 2006

(54) Method and device for encoding/decoding video signals using temporal and spatial correlations between macroblocks

(76) Inventors: Seung Wook Park, Sungnam-si (KR); Ji Ho Park, Sungnam-si (KR); Byeong Moon Jeon, Sungnam-si (KR)

Correspondence Address: HARNESS, DICKEY & PIERCE, P.L.C., P.O. BOX 8910, RESTON, VA, 20195, US

(21) Appl. No.: 11/231,814

(22) Filed: Sep. 22, 2005

Related U.S. Application Data
(60) Provisional application No. 60/612,182, filed on Sep. 23, 2004.

(30) Foreign Application Priority Data
Dec. 30, 2004 (KR) 10-2004-0116899

(51) Int. Cl. H04N 7/12; H04N 11/04; H04N 11/02; H04B 1/66

(52) U.S. Cl. 375/240.12; 375/240.25; 375/240.24

(57) ABSTRACT

A method and a device for encoding/decoding video signals by motion compensated temporal filtering. Blocks of a video frame are encoded/decoded using temporal and spatial correlations according to a scalable Motion Compensated Temporal Filtering (MCTF) scheme. When a video signal is encoded using a scalable MCTF scheme, a reference block of an image block in a frame in a video frame sequence constituting the video signal is searched for in temporally adjacent frames. If a reference block is found, an image difference (pixel-to-pixel difference) of the image block from the reference block is obtained, and the obtained image difference is added to the reference block. If no reference block is found, pixel difference values of the image block are obtained based on at least one pixel adjacent to the image block in the same frame. Thus, the encoding procedure uses the spatial correlation between image blocks, improving the coding efficiency.

This application claims priority under 35 U.S.C. §119 on U.S. provisional application 60/612,182, filed Sep. 23, 2004, the entire contents of which are hereby incorporated by reference.

### BACKGROUND OF THE INVENTION

1. Field of the Invention

The present invention relates to a method and a device for encoding and decoding video signals.

2. Description of the Related Art

A number of standards have been suggested for compressing video signals. One typical standard is MPEG, which has been adopted as a standard for recording movie content and the like on a recording medium such as a DVD and is widely used. Another standard is H.264, which is expected to be used as a standard for high-quality TV broadcast signals in the future.

While TV broadcast signals require high bandwidth, it is difficult to allocate such high bandwidth for the type of wireless transmissions/receptions performed by mobile phones and notebook computers, for example. Thus, video compression standards for use with mobile devices must have high video signal compression efficiencies.

Such mobile devices have a variety of processing and presentation capabilities such that a variety of compressed video data forms must be prepared. This indicates that the same video source must be provided in a variety of forms corresponding to a variety of combinations of variables such as the number of frames transmitted per second, resolution, the number of bits per pixel, etc. Thus, the variety of compressed video signals that must be prepared are proportional to the number of combinations of variables. This imposes a great burden on content providers.

In view of the above, content providers prepare high-bitrate compressed video signals for each video source and perform, when receiving a request from a mobile device, a process of decoding the compressed video signals and encoding it back into video signals suited to the video processing capabilities of the mobile device when receiving a request from the mobile device as part of providing the requested video signals to the mobile device. However, this method entails a transcoding procedure including decoding, scaling and encoding processes, which causes some time delay in providing the requested signals to the mobile device. The transcoding procedure also requires complex hardware and algorithms to cope with the wide variety of target encoding formats.

A Scalable Video Codec (SVC) has been developed in an attempt to overcome these problems. In this scheme, video signals are encoded into a sequence of pictures with the highest image quality while ensuring that a part of the encoded picture sequence (specifically, a partial sequence of pictures intermittently selected from the total sequence of pictures) can be used to represent the video signals with a low image quality.

Motion Compensated Temporal Filtering (MCTF) is an encoding and decoding scheme that has been suggested for use in the scalable video codec. However, the MCTF scheme requires a high compression efficiency (i.e., a high coding rate) for reducing the number of bits transmitted per second since it is highly likely to be applied to mobile communication where bandwidth is limited, as described above.

### SUMMARY OF THE INVENTION

The present invention relates to encoding and decoding a video signal by motion compensated temporal filtering.

In one embodiment, a spatial correlation between video signals, in addition to a temporal correlation thereof, is utilized when encoding blocks in a video frame in a scalable MCTF scheme so as to reduce the amount of coded data of the blocks, thereby improving coding efficiency.

In another embodiment, the present invention relates to a method and device for decoding a bitstream encoded using spatial image correlation in addition to temporal correlation.

In a further embodiment, when a video signal is encoded in a scalable MCTF scheme, a reference block of an image block present in an arbitrary frame in a video frame sequence constituting the video signal is searched for in temporally adjacent frames prior to and subsequent to the arbitrary frame; if the reference block is found, a difference value of the image block from the reference block is obtained and the obtained difference value is added to the reference block; and, if the reference block is not found, a difference value of the image block is obtained based on at least one pixel that is adjacent to the image block and is present in the arbitrary frame.

In a further embodiment, it is determined whether a difference value of an image block present in a frame in a first sequence of frames having difference values has been obtained based on a different block present in a frame in a second sequence of frames different from the first frame sequence or based on at least one pixel adjacent to the image block. The difference value of the image block is subtracted from an image value of the different block and an original image value of the image block is restored using both the difference value of the image block and the image value of the different block from which the difference value of the image block has been subtracted, or an original image value of the image block is restored using both the difference value of the image block and a pixel value of the at least one pixel adjacent to the image block, depending on a result of the determination.

In a further embodiment of the present invention, if an image block of a frame to be encoded is assigned an intra-mode in which a reference block of the image block is not found in temporally adjacent frames prior to and subsequent to the frame or in divided slices of the adjacent frames, information indicating the intra-mode, which is discriminated from information indicating an inter-mode in which the reference block is found in the temporally adjacent frames or slices, is recorded in header information of the image block and is then transmitted after being encoded. When an image block present in a received frame is decoded, it is determined whether a different block in adjacent frames or slices thereof prior to and subsequent to the received frame or at least one pixel adjacent to the image block is to be used to restore an original image value of the image block.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a video signal encoding device to which a scalable video signal compression method according to the present invention is applied;

FIG. 2 is a block diagram of a filter that performs image estimation/prediction and update operations in the MCTF encoder shown in FIG. 1;

FIG. 3 illustrates various modes of a macroblock produced by the filter of FIG. 2 according to an embodiment of the present invention;

FIG. 4 illustrates a block mode field included in a macroblock header;

FIG. 5 illustrates how the filter of FIG. 2 produces an intra-mode macroblock according to an embodiment of the present invention;

FIG. 6 is a block diagram of a device for decoding a bitstream encoded by the device of FIG. 1 according to an example embodiment of the present invention; and

FIG. 7 is a block diagram of an inverse filter that performs inverse estimation/prediction and update operations in an MCTF decoder shown in FIG. 6 according to an example embodiment of the present invention.

### DETAILED DESCRIPTION OF PREFFERRED EMBODIMENTS

Example embodiments of the present invention will now be described in detail with reference to the accompanying drawings.

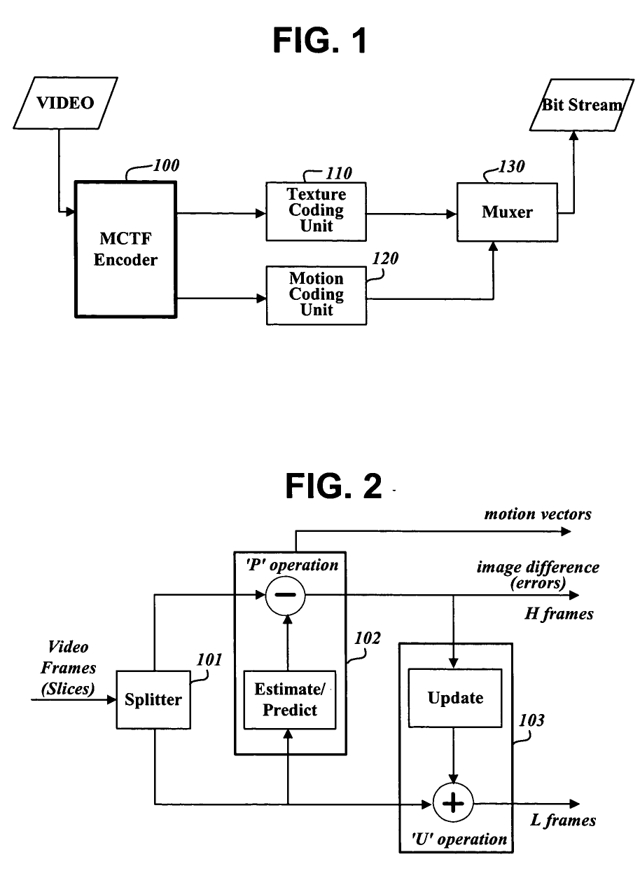

FIG. 1 is a block diagram of a video signal encoding device to which a scalable video signal compression method according to the present invention is applied.

The video signal encoding device shown in FIG. 1 comprises an MCTF encoder 100, a texture coding unit 110, a motion coding unit 120, and a muxer (or multiplexer) 130. The MCTF encoder 100 encodes an input video signal in units of macroblocks in an MCTF scheme, and generates suitable management information. The texture coding unit 110 converts information of encoded macroblocks into a compressed bitstream. The motion coding unit 120 encodes motion vectors of macroblocks obtained by the MCTF encoder 100 into a compressed bitstream according to a specified scheme. The muxer 130 encapsulates output data from the texture coding unit 110 and motion vector data of the motion coding unit 120 into a set format. The muxer 130 multiplexes the encapsulated data into a set transmission format and outputs a bitstream.

The MCTF encoder 100 performs a motion estimation/prediction operation on each video frame to extract a temporal correlation between the video frame and its neighbor video frame or a spatial correlation within the same video frame. The MCTF encoder 100 also performs an update operation in such a manner that an image error or difference of each frame from its neighbor frame is added to the neighbor frame. FIG. 2 is a block diagram of a filter for carrying out these operations.

As shown in FIG. 2, the filter includes a splitter 101, an estimator/predictor 102, and an updater 103. The splitter 101 splits an input video frame sequence into earlier and later frames in pairs of successive frames (for example, into odd and even frames). The estimator/predictor 102 performs motion estimation/prediction operations on each macroblock in an arbitrary frame in the frame sequence. As described in more detail below, the estimator/predictor 102 searches for a reference block of each macroblock of the arbitrary frame in neighbor frames prior to and subsequent to the arbitrary frame and calculates an image difference (i.e., a pixel-to-pixel difference) of the macroblock from the reference block and a motion vector between the macroblock and the reference block. Or, the estimator/predictor 102 may calculate an image difference value of each macroblock of an arbitrary frame using pixels adjacent to the macroblock in the same frame. The updater 103 performs an update operation in which for a macroblock, whose reference block has been found by the motion estimation, the calculated image error (difference) value of the macroblock from the reference block is normalized and the normalized value is added to the reference block.

The operation carried out by the updater 103 is referred to as a ‘U’ operation, and a frame produced by the ‘U’ operation is referred to as an ‘L’ (low) frame. The filter of FIG. 2 may perform its operations on a plurality of slices simultaneously and in parallel, which are produced by dividing a single frame, instead of performing its operations in units of frames. In the following description of the embodiments, the term ‘frame’ is used in a broad sense to include a ‘slice’.

The estimator/predictor 102 divides each of the input video frames into macroblocks of a set size. For each divided macroblock, the estimator/predictor 102 searches for a block, whose image is most similar to that of each divided macroblock, in neighbor frames prior to and subsequent to the input video frame. That is, the estimator/predictor 102 searches for a macroblock having the highest temporal correlation with the target macroblock. A block having the most similar image to a target image block has the smallest image difference from the target image block. The image difference of two image blocks is defined, for example, as the sum or average of pixel-to-pixel differences of the two image blocks. Accordingly, of macroblocks in a previous/next neighbor frame which have a set threshold pixel-to-pixel difference sum (or average) or less from a target macroblock in the current frame, a macroblock having the smallest difference sum (or average) (i.e., the smallest image difference) from the target macroblock is referred to as a reference block(s). For each macroblock of a current frame, two reference blocks may be present in two frames prior to and subsequent to the current frame, or in one frame prior and in one frame subsequent to the current frame.

If the reference block is found, the estimator/predictor 102 calculates and outputs a motion vector from the current block to the reference block, and also calculates and outputs errors or differences of pixel values of the current block from pixel values of the reference block, which may be present in either the prior frame or the subsequent frame. Alternatively, the estimator/predictor 102 calculates and outputs differences of pixel values of the current block from average pixel values of two reference blocks, which may be present in the prior and subsequent frames. If no macroblock providing a set threshold image difference or less from the current macroblock is found in the two neighbor frames via the motion estimation operation, the estimator/predictor 102 obtains the image difference for the current macroblock using values of pixels adjacent to the current macroblock, and does not obtain a motion vector of the current macroblock. An intra-mode is assigned to each macroblock whose reference block is not found, so that it is discriminated from an inter-mode macroblock whose reference block is found and whose motion vector is obtained as described above.

Such an operation of the estimator/predictor 102 is referred to as a ‘P’ operation. A frame having an image difference, which the estimator/predictor 102 produces via the ‘P’ operation, is referred to as an ‘H’ (high) frame since this frame has high frequency components of the video signal.

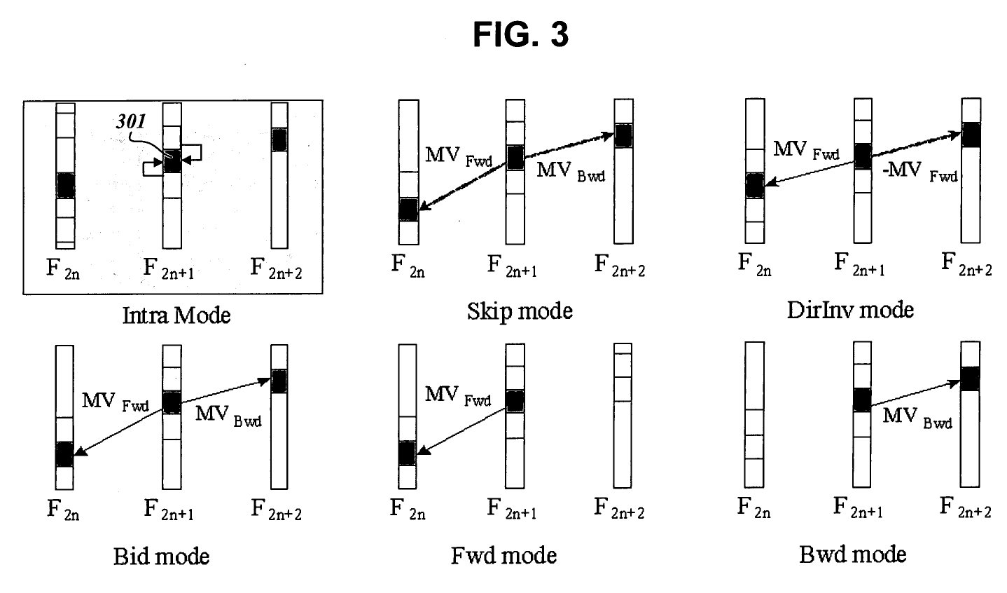

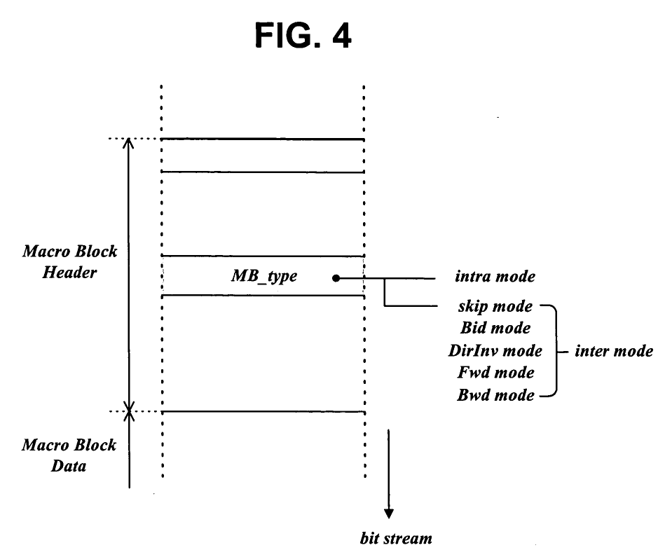

One of the intra-mode and various inter-modes (Skip, DirInv, Bid, Fwd, and Bwd modes) shown in FIG. 3 is determined for each macroblock in the above procedure, and a selectively obtained motion vector value is transmitted to the motion coding unit 120. The MCTF encoder 100 transmits a set mode value of the macroblock to the texture coding unit 110 after inserting the mode value into a field (MB_type) at a set position of a header area of the macroblock as shown in FIG. 4.

The inter-modes of FIG. 3 will now be described in detail. The estimator/predictor 102 assigns a value indicating the skip mode to the block mode value of the current macroblock if the motion vector of the current macroblock with respect to its reference block can be derived from motion vectors of neighbor or adjacent macroblocks. For example, the estimator/predictor 102 assigns a value indicating the skip mode if the average of motion vectors of left and top macroblocks can be regarded as the motion vector of the current macroblock. If the current macroblock is assigned a skip mode, no motion vector is provided to the motion coding unit 120 since the decoder can sufficiently derive the motion vector of the current macroblock. The current macroblock is assigned a bidirectional (Bid) mode if two reference blocks of the current macroblock are present in the prior and subsequent frames. The current macroblock is assigned a direction inverse (DirInv) mode if the two motion vectors have the same magnitude in opposite directions. The current macroblock is assigned a forward (Fwd) mode if the reference block of the current macroblock is present only in the prior frame. The current macroblock is assigned a backward (Bwd) mode if the reference block of the current macroblock is present only in the subsequent frame.

When performing the ‘P’ operation, the estimator/predictor 102 obtains pixel difference values of the current macroblock using top and/or left pixels thereof if no reference block of the current macroblock is present in temporally adjacent frames prior to and/or subsequent to the current frame, i.e., if the prior and subsequent frames have no macroblock with a set threshold image difference or less from the current macroblock. For example, if each macroblock is composed of 16×16 pixels, a vertical line of 16 pixels immediately above the current macroblock or a vertical line of 16 pixels immediately to the left of the current macroblock are commonly used to obtain the pixel difference values of the current macroblock. Instead of using the pixel lines, an upper-left adjacent pixel may be used or the average of pixel values of a certain number of pixels may be used. To determine which pixels are used to obtain the pixel difference values of the current macroblock, a pixel selection method, which minimizes the image difference value of the current macroblock, is selected from a plurality of pixel selection methods.

It is desirable that pixels in macroblocks located above and to the left of the current macroblock be used to obtain the error or difference values of the current macroblock for, at least, the following reason. When the current macroblock is decoded in the decoder, the top and left macroblocks have already been decoded which allows the decoder to easily restore the pixel values of the current macroblock using the already decoded pixel values of the macroblocks above and to the left of the current macroblock.

If pixel difference values of the current macroblock are obtained using a set of adjacent pixels in the same frame in such a manner, the mode value of the current macroblock is assigned a value indicating an ‘intra-mode’, which is distinguished from the inter-modes values (Skip, DirInv, Bid, Fwd, and Bwd) shown in FIG. 3. No motion vector value is obtained for the intra-mode since no inter-block motion estimation is performed for the intra-mode.

When performing the ‘P’ operation, the estimator/predictor 102 determines one of the pixel selection methods, which minimizes the image difference value of the current macroblock, as describe above. Accordingly, sub-modes corresponding to possible pixel selection methods may be provided for the intra-mode, and one of the sub-modes indicating the selected pixel selection method may be additionally recorded in a header of the current macroblock to inform the decoder of which set or combination of pixels have been selected.

Assigning the intra-mode to a macroblock makes it possible to decrease the data value of the macroblock using the correlation between spatially adjacent pixels, thereby reducing the amount of data to be coded by the texture coding unit 110.

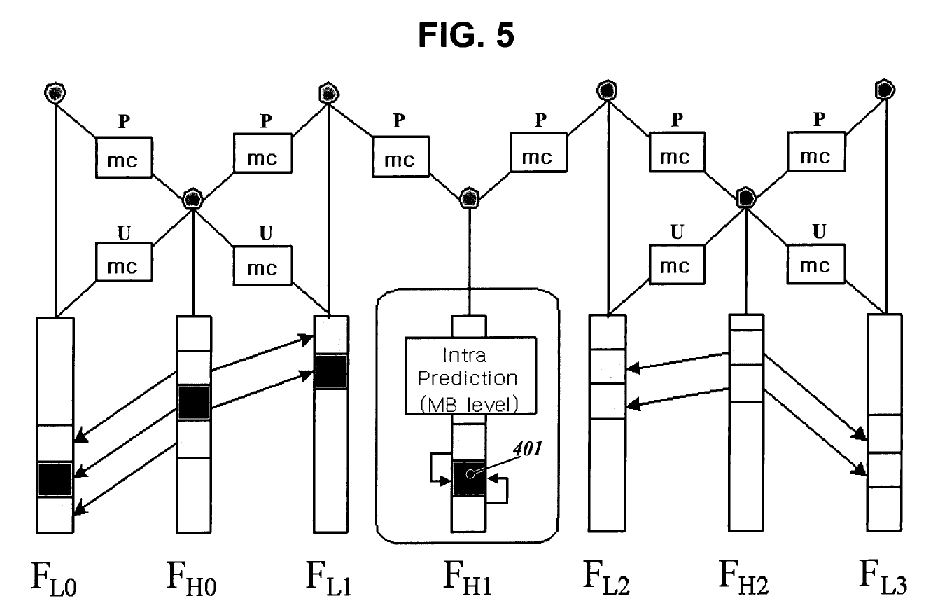

FIG. 5 illustrates how the filter of FIG. 2 produces an intra-mode macroblock.

Each pixel of an intra-mode macroblock 401 in a target H frame F_{H1} shown in FIG. 5 has a difference value based on a set of adjacent pixels in the target H frame F_{H1} whose image difference is to be produced by the ‘P’ operation of the estimator/predictor 102. The macroblock 401 is assigned the intra-mode because no macroblock having a set threshold image difference or less from the macroblock 401 is found in neighbor frames F_{L1} and F_{L2} prior to and subsequent to the frame F_{H1} including the macroblock 401.

The updater 103 does not perform the addition operation for macroblocks in the H frame, which are assigned the intra-mode, since the intra-mode macroblocks have no reference block. That is, only for macroblocks in the H frame which are assigned the inter-mode, does the updater 103 perform the operation for adding the image difference of each macroblock in the H frame with the image of one or two reference blocks present in two neighbor L frames prior to and subsequent to the H frame.

Macroblocks in the target frame F_{H1}, which do not have the intra-mode, may have other modes, i.e., inter-modes such as a bidirectional mode, forward mode, backward mode, etc. These inter-mode macroblocks have reference blocks in L frames F_{L1} and/or F_{L2} to be produced by the ‘U’ operation. An image difference of the intra-mode macroblock 401, which is obtained by the ‘P’ operation, is not used for the update operation since the intra-mode macroblock 401 does not have a reference block for motion estimation. On the other hand, image differences of macroblocks having no intra-mode are used for the update operation such that the image differences thereof are normalized and added to image values of their reference blocks, thereby producing L frames (or slices) F_{L1} and/or F_{L2}.

The bitstream encoded according to the method described above may be transmitted by wire or wireless to a decoding device or may be delivered via recording media. The decoding device restores the original video signal of the encoded bitstream according to the method described below.

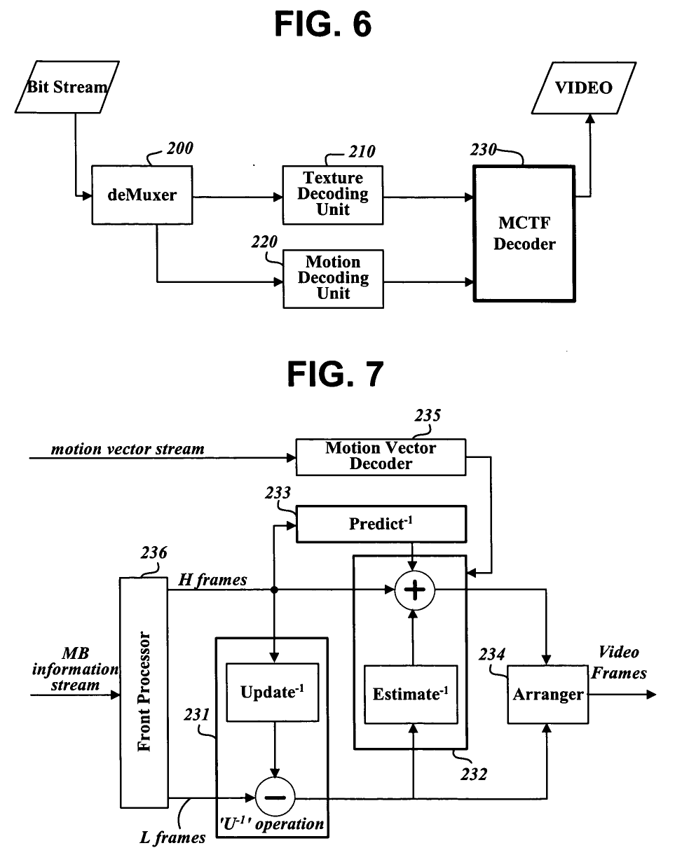

FIG. 6 is a block diagram of a device for decoding a bitstream encoded by the device of FIG. 1. The decoding device of FIG. 6 includes a demuxer (or demultiplexer) 200, a texture decoding unit 210, a motion decoding unit 220, and an MCTF decoder 230. The demuxer 200 separates a received bitstream into a compressed motion vector stream and a compressed macroblock information stream. The texture decoding unit 210 decodes the compressed bitstream. The motion decoding unit 220 decodes the compressed motion vector information. The MCTF decoder 230 decodes the bitstream containing macroblock information and the motion vector according to an MCTF scheme.

The MCTF decoder 230 includes, as an internal element, an inverse filter as shown in FIG. 7 for decoding an input bitstream into its original frame sequence.

The inverse filter of FIG. 7 includes a front processor 236, an inverse updater 231, an inverse estimator 232, an inverse predictor 233, an arranger 234, and a motion vector decoder 235. The front processor 236 divides an input bitstream into H frames and L frames, and analyzes the header information of macroblocks. The inverse updater 231 subtracts pixel difference values of input H frames from corresponding pixel values of input L frames. The inverse estimator 232 restores inputted H frames to frames having original images using the H frames and the L frames from which the image differences of the H frames have been subtracted in the inverse updater 231. Here, the L frame used along with the H frame to restore the input H frame are the frames generated by subtracting the image difference of the H frame from the inputted L frame. The inverse predictor 233 restores intra-mode macroblocks in input H frames to macroblocks having original images using pixels adjacent to the intra-mode macroblocks. The arranger 234 interleaves the frames, completed by the inverse estimator 232 and the inverse predictor 233, between the L frames output from the inverse updater 231, thereby producing a normal video frame sequence. The motion vector decoder 235 decodes an input motion vector stream into motion vector information of each block and provides the motion vector information to the inverse estimator 232.

The front processor 236 analyzes and divides an input bitstream into an L frame sequence and an H frame sequence. In addition, the front processor 236 uses header information in each macroblock in an H frame to notify the inverse estimator 232 and the inverse predictor 233 of whether each macroblock in the H frame has been assigned the intra- or inter-mode. The inverse estimator 232 specifies an inter-mode macroblock in an H frame, and uses a motion vector received from the motion vector decoder 235 to determine a reference block of the specified macroblock, which is present in an L frame corresponding to the specified macroblock. The inverse estimator 232 can restore an original image of the inter-mode macroblock by adding pixel values of the reference block to pixel difference values of the inter-mode macroblock. The inverse predictor 233 can specify an intra-mode macroblock of an H frame to restore an original image of the intra-mode macroblock. Inter-mode macroblocks and intra-mode macroblocks, whose pixel values are restored by the inverse estimator 232 and the inverse predictor 233, are combined to produce a single complete video frame.

To determine which set of adjacent pixels will be used to restore an image difference of an intra-mode macroblock to its original image, the inverse predictor 233 receives information of the sub-mode of the intra-mode macroblock from the front processor 236. If the sub-mode is confirmed, the inverse predictor 233 determines a set of pixels and a reference value setting method based on a pixel selection method specified by the confirmed sub-mode. For example, the inverse predictor 233 determines whether to use adjacent pixel values of the intra-mode macroblock without alteration or the average of adjacent pixel values as a reference value of the intra-mode macroblock. After the determination, the inverse predictor 233 restores the original image of the intra-mode macroblock by adding the determined reference value to the pixel values of the intra-mode macroblock.

When performing the operation for subtracting the image difference of an input H frame from the image of an input L frame, the inverse updater 231 does not perform the subtraction operation for macroblocks in the H frame, which are assigned the intra-mode, since the intra-mode macroblocks have no reference block. That is, only for macroblocks in the H frame which are assigned the inter-mode, does the inverse updater 231 perform the operation for subtracting the image difference of each macroblock in the H frame from the image of one or two reference blocks present in two neighbor L frames prior to and subsequent to the H frame.

The above decoding method restores an MCTF-encoded bitstream to a complete video frame sequence. In the case where the estimation/prediction and update operations have been performed for a GOP N times in the MCTF encoding procedure described above, a video frame sequence with the original image quality is obtained if the inverse estimation/prediction and update operations are performed N times, whereas a video frame sequence with a lower image quality and at a lower bitrate is obtained if the inverse estimation/prediction and update operations are performed less than N times. Accordingly, the decoding device is designed to perform inverse estimation/prediction and update operations to the extent suitable for its performance.

The decoding device described above can be incorporated into a mobile communication terminal or the like or into a recording media playback device.

As is apparent from the above description, a method and a device for encoding/decoding video signals according to the present invention have advantages in that a spatial correlation between video signals, in addition to a temporal correlation thereof, is utilized in an MCTF encoding procedure to reduce the amount of coded data for spatially-correlated macroblocks in a video frame, thereby improving the overall MCTF coding efficiency.

Although this invention has been described with reference to the preferred embodiments, it will be apparent to those skilled in the art that various improvements, modifications, replacements, and additions can be made in the invention without departing from the scope and spirit of the invention. Thus, it is intended that the invention cover the improvements, modifications, replacements, and additions of the invention, provided they come within the scope of the appended claims and their equivalents.

What is claimed is:

1. A method of decoding an encoded video signal by inverse motion compensated temporal filtering, comprising:
selectively adding an image block and one of a reference block associated with the image block and at least one pixel adjacent to the image block.

2. The method of claim 1, wherein the selectively adding step adds the first image block and the reference block if the image block was encoded according to an inter-mode.

3. The method of claim 2, wherein the selectively adding step adds the image block to the at least one pixel if the image block was encoded according to an intra-mode.

4. The method of claim 3, further comprising:
obtaining the decoding mode of the image block based on the information in the encoded video signal.

5. The method of claim 4, wherein the obtaining step obtains the decoding mode from a header of the image block.

6. The method of claim 3, wherein the selectively adding step performs according to a sub-mode of the intra-mode.

7. The method of claim 6, wherein the obtaining step obtains the sub-mode of the intra-mode from a header of the image block.

8. The method of claim 7, wherein the selectively adding step adds the image block to at least one pixel adjacent to the image block according to the sub-mode.

9. The method of claim 2, wherein the selectively adding step does not add the image block to the reference block if the image block was encoded according to an intra-mode.

10. A method of decoding an encoded video signal by inverse motion compensated temporal filtering, comprising:
selectively subtracting a first image block from a second image block based on an encoding mode of the first image block.

11. The method of claim 10, wherein the selectively subtracting step subtracts the first image block from the second image block if the first image block was encoded according to an inter-mode.

12. The method of claim 11, wherein the selectively subtracting step does not subtract the first image block from the second image block if the first image block was encoded according to an intra-mode.

13. The method of claim 12, further comprising:
obtaining the encoding mode of the first image block based on information in the encoded video signal.

14. The method of claim 13, wherein the obtaining step obtains the encoding mode from a header of the first image block.

15. The method of claim 10, wherein the selectively subtracting step does not subtract the first image block from the second image block if the first image block was encoded according to an intra-mode.

16. The method of claim 10, further comprising:
obtaining the encoding mode of the first image block based on information in the encoded video signal.

17. The method of claim 16, wherein the obtaining step obtains the encoding mode from a header of the first image block.

18. A method of decoding an encoded video signal by inverse motion compensated temporal filtering, comprising:
selectively either subtracting a first image block from a second image block or adding the first image block and one of a reference block associated with the first image block and at least one pixel adjacent to the image block, based on an encoding mode of the first image block.

19. The method of claim 18, wherein the selectively adding step adds the first image block and the reference block if the image block was encoded according to an inter-mode.

20. The method of claim 18, wherein the selectively adding step adds the image block to the at least one pixel if the image block was encoded according to an intra-mode.

21. The method of claim 18, further comprising:
obtaining the decoding mode of the image block based on the information in the encoded video signal.

22. The method of claim 21, wherein the obtaining step obtains the decoding mode from a header of the image block.

23. The method of claim 20, wherein the selectively adding or subtracting step performs according to a sub-mode of the intra-mode.

24. A method of encoding a video signal by inverse motion compensated temporal filtering, comprising:
selectively subtracting a first image block and one of a second block associated with the first image block and at least one pixel adjacent to the first image block.

25. The method of claim 24, wherein the selectively subtracting step does not subtract the first image block from the reference block if the image block difference is not equal to or less than a threshold value.

26. A device for decoding an encoded video signal by inverse motion compensated temporal filtering, comprising:
an inverse updater for selectively adding an image block from the encoded video signal and one of a reference block associated with the image block and at least one pixel adjacent to the image block.

27. A device for encoding a video signal by inverse motion compensated temporal filtering, comprising:
an updater for selectively subtracting a first image block from a frame sequence of the video signal and one of a second block associated with the first image block and at least one pixel adjacent to the first image block.
